(19) United States
(12) Patent Application Publication
(10) Pub. No.: US 2003/0174838 A1
(43) Pub. Date: Sep. 18, 2003

(54) Method and apparatus for user-friendly peer-to-peer distribution of digital rights management protected content and mechanism for detecting illegal content distributors

(75) Inventor: Oliver Bremer, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/099,931

(22) Filed: Mar. 14, 2002

(51) Int. Cl. H04L 9/32

(52) U.S. Cl. 380/270; 713/201

(57) ABSTRACT

A method and apparatus are provided for forwarding peer-to-peer content in a wireless network having a network infrastructure, in which neither a wireless sender nor a wireless recipient requires content personalization assistance from the network infrastructure for encryption or consumption of protected content. In a first step, the wireless sender sends an initial message to the wireless recipient. In a second step, the wireless recipient sends a device certificate having a public key to the wireless sender. In a third step, the wireless sender personalizes the content by encrypting the content (or content encryption key) using a public key of the wireless recipient, signing encrypted content (or content encryption key) using a private key of the wireless sender, and sending the protected content (and/or content encryption key) together with a device certificate of the wireless sender to the wireless recipient. In a fourth step, the wireless recipient verifies the protected content (or content encryption key) by verifying the device certificate of the wireless sender, verifying the private key of the wireless sender, and applying a private key of the wireless recipient in order for the recipient to consume the protected content. The protected content is digital rights management (DRM) protected content.

### BACKGROUND OF THE INVENTION

1. Field of Invention

The present invention relates to a wireless network; and more particularly relates to a wireless network in which digital rights management (DRM) protected content is sent from one mobile phone or terminal to another.

2. Description of Related Art

In general, DRM protection is based on the principle that every end-entity able to consume DRM protected content is equipped with a cryptographic key, which usually is unique for every end-entity.

DRM protected content is distributed, possibly together with a set of consumption rights, in encrypted form. Thus, only authorized parties, usually those that have paid for the content, are able to consume the content. This is done, for example, by encrypting the content with the public key matching the recipient's private DRM key (asymmetric key encryption). For practical reasons, usually a hybrid scheme is chosen, wherein DRM protected content is encrypted under a content encryption key (CEK) using symmetric encryption. The CEK in turn is then encrypted with the public DRM key matching the recipient's private DRM key. The CEK may be accompanied by consumption rights (which may also be encrypted) expressing the usage rules for the DRM protected content.

The effect is the same for both approaches, i.e., only authorized parties are able to consume the DRM protected content (if implemented securely and correctly). The two approaches, however, also share a drawback originating from the fact that every end-entity is equipped with a unique DRM key: content (or the CEK) has to be personalized for every device prior to consumption.

Usually, DRM content is protected, i.e., encrypted, (and therefore personalized) by the network side for various reasons, e.g., to guarantee payment for the content. Typically, the network infrastructure has a server for personalizing content transported in the wireless network. The network centric nature of current approaches, however, is not very suitable for certain types of content, e.g., free content. The most prominent example being content intended for preview purposes.

Because of this, peer-to-peer forwarding of DRM protected content and immediate consumption thereafter is not possible. Either the recipient of DRM protected content that has been forwarded in a peer-to-peer fashion must establish connection to the network before being able to consume the content, or the sender must in the first place send the content to the network which will personalize the content for and route it to the recipient. (The latter case, however, is not classified as true peer-to-peer superdistribution anymore.)

In addition, DRM implementations in the Internet world generally do not offer the possibility to superdistribute content in a peer-to-peer fashion without network access, e.g., for preview purposes prior to purchasing.

In view of the aforementioned, there is a need in the art to solve the problem of user-friendly peer-to-peer forwarding of DRM protected content (or CEK) without requiring network access for personalization of the DRM protected content (or CEK) while at the same time enabling the detection and prevention of distributing pirated DRM content.

In the following, the term ‘DRM protected content’ refers at a minimum to the DRM protected content itself in the case where the content is encrypted directly with the recipient's public DRM key. In the case of hybrid encryption, the term ‘DRM protected content’ also at a minimum comprises the CEK, and usage rights containing or accompanying the CEK.

### SUMMARY OF INVENTION

In its broadest sense, the present invention provides a new and unique method and apparatus for forwarding peer-to-peer content in a wireless network having a network infrastructure, in which a wireless sender encrypts protected content and a wireless recipient consumes the protected content without content personalization assistance from the network infrastructure.

In one step, the wireless sender sends a message to the wireless recipient. The message may be a wake up message that includes an international mobile equipment identity (IMEI), mobile station international integrated services digital network number (MSISDN), and/or a configurable sender name.

In another step, the wireless recipient sends a certificate containing a public DRM key matching the wireless recipient's private DRM key to the wireless sender.

In another step, the wireless sender personalizes the content by encrypting the content (or content encryption key) using a public DRM key of the wireless recipient, signing the encrypted content (or content encryption key) using a private key of the wireless sender, and sending the protected content (or content encryption key) together with a device certificate of the wireless sender to the wireless recipient.

In still another step, the wireless recipient verifies the wireless sender's signature of the forwarded protected content (or content encryption key) by using the device certificate of the wireless sender, and applying a private DRM key of the wireless recipient in order for the wireless recipient to consume the protected content.

Alternatively, in the first step, in lieu of sending the international mobile equipment identity, the MSISDN, or the sender name, the wireless sender may instead send a message having a device certificate rather than doing so in the third step. The device certificate can contain the international mobile equipment identity.

The protected content is DRM protected content.

The invention also provides a wireless network having two wireless terminals and a network infrastructure for forwarding peer-to-peer content from one wireless terminal to another wireless terminal, in which each wireless terminal comprises a peer-to-peer forwarding/reception of DRM protected content module for either encrypting or consuming protected content without content personalization assistance from the network infrastructure.

The invention provides an important contribution to the wireless world and solves a problem particularly important to the mobile network domain. The invention defines a process that enables peer-to-peer distribution of DRM protected content that must be personalized for the recipient prior to consumption. With the invention, the sending terminal is able to personalize the content in a non-network centric fashion.

The invention also greatly obstructs the circulation of pirated DRM content by requiring both the wireless sender terminal and the wireless receiver terminal to be tampered with in order to exchange pirated DRM content without the possibility of being detected. Thus the invention reduces the number of rogue terminals participating in the distribution of pirated DRM content.

By applying a combination of accountability and non-repudiation together with rewarding honest terminals, the invention reverses the reversed threat model of DRM, and provides a way to gather information for forensic analysis, thus enabling identification of terminals and prosecution of distributors of pirated DRM content. In effect, the invention permits rewarding honest end-entities reporting distributors of pirated DRM content to the DRM system operator. Thus, the invention actively reduces the number of end-entities consuming and exchanging pirated DRM content, crucial to keeping the fraud level below some threshold vital to businesses to remain profitable.

Also, the overall mechanism for identifying end-entities distributing pirated DRM content and rewarding honest end-entities reporting distributors of pirated DRM content is new and unique. By reversing the reversed threat model, now not every user is a potential adversary anymore, rather every user is a potential DRM enforcement agent.

In the case where multiple devices share the same private DRM key (so called group or domain concept), content must be personalized for every set, that is a group or domain, of devices sharing the same private DRM key prior to consumption. In this case, the invention enables the user-friendly peer-to-peer distribution of DRM protected content between devices belonging to different sets.

### BRIEF DESCRIPTION OF THE DRAWING

The drawing, not drawn to scale, includes the following Figures:

FIG. 1 is a diagram of a wireless network having a network infrastructure and two terminals that forms the subject matter of the present invention.

FIG. 2 is a diagram of a flow chart of the basic steps of the present invention.

FIG. 3 is a block diagram of a wireless terminal that forms the subject matter of the present invention.

FIG. 4 is a diagram of an alternative embodiment of the present invention.

### DETAILED DESCRIPTION OF INVENTION

### The Basic Invention

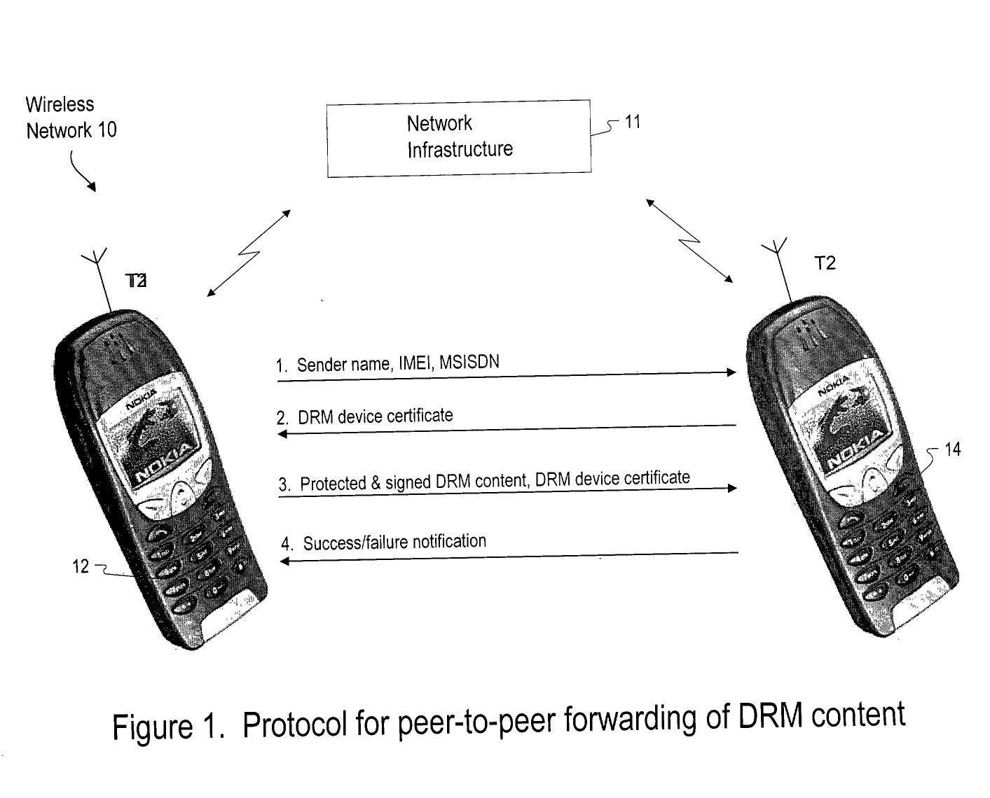

FIG. 1 shows a wireless network generally indicated as 10 having a network infrastructure 11, a first wireless phone, terminal or device 12 and a second wireless phone, terminal or device 14. As shown, the first terminal 12 is a wireless sender T1 that forwards content in a peer-to-peer fashion to the second terminal 14 which is a wireless recipient T2. According to the present invention, in the wireless network 10 the wireless sender 12 encrypts the protected content (or the content encryption key) and the wireless recipient 14 consumes the protected content without content personalization assistance from the network infrastructure 11.

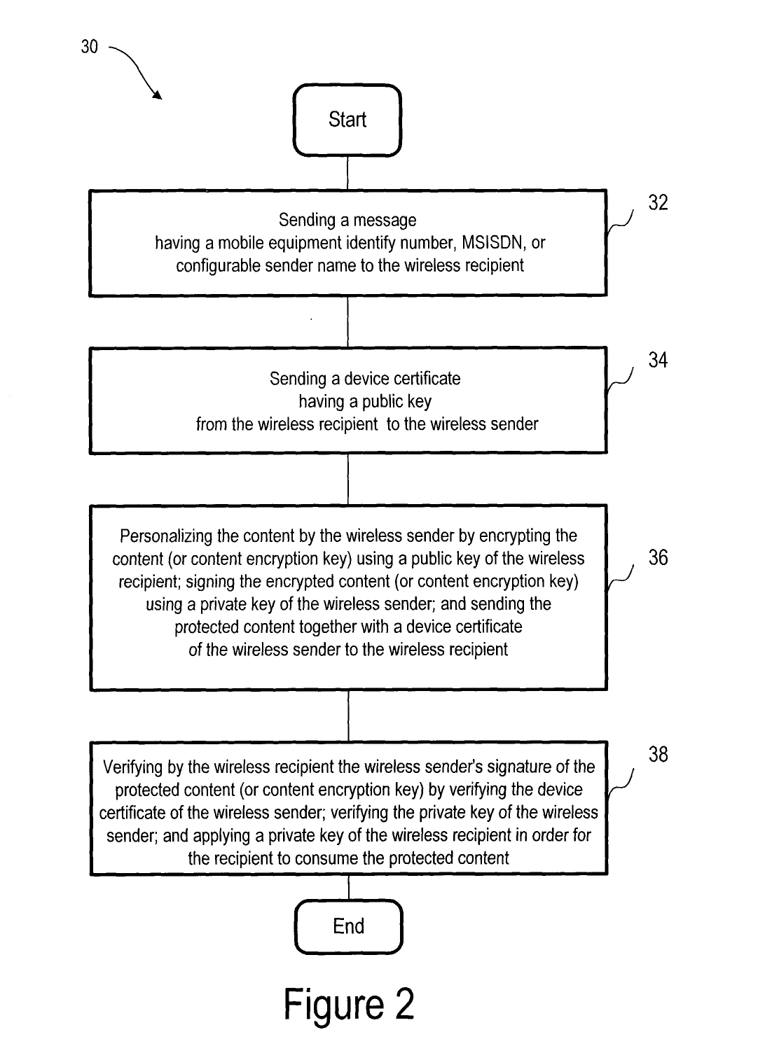

FIG. 2 shows a flow chart having basic steps generally indicated as 30 of a peer-to-peer forwarding and reception of DRM protected content protocol.

In a step 32, the wireless sender 12 sends a message to the wireless recipient 14. In one embodiment, the message includes at least an international mobile equipment identity (IMEI) number, MSISDN, or configurable sender name.

In a step 34, the wireless recipient 14 sends a device certificate having a public key to the wireless sender 12.

In a step 36, the wireless sender 12 personalizes the content by encrypting the content (or content encryption key) using a public key of the wireless recipient 14, signing the encrypted content (or content encryption key) using a private key of the wireless sender 12, and sending the protected content (or content encryption key) together with a device certificate of the wireless sender 12 to the wireless recipient 14.

In a step 38, the wireless recipient 14 verifies the wireless sender's signature on the protected content (or content encryption key) by using the device certificate of the wireless sender 12, and applying a private key of the wireless recipient 14 in order for the wireless recipient 14 to consume the protected content.

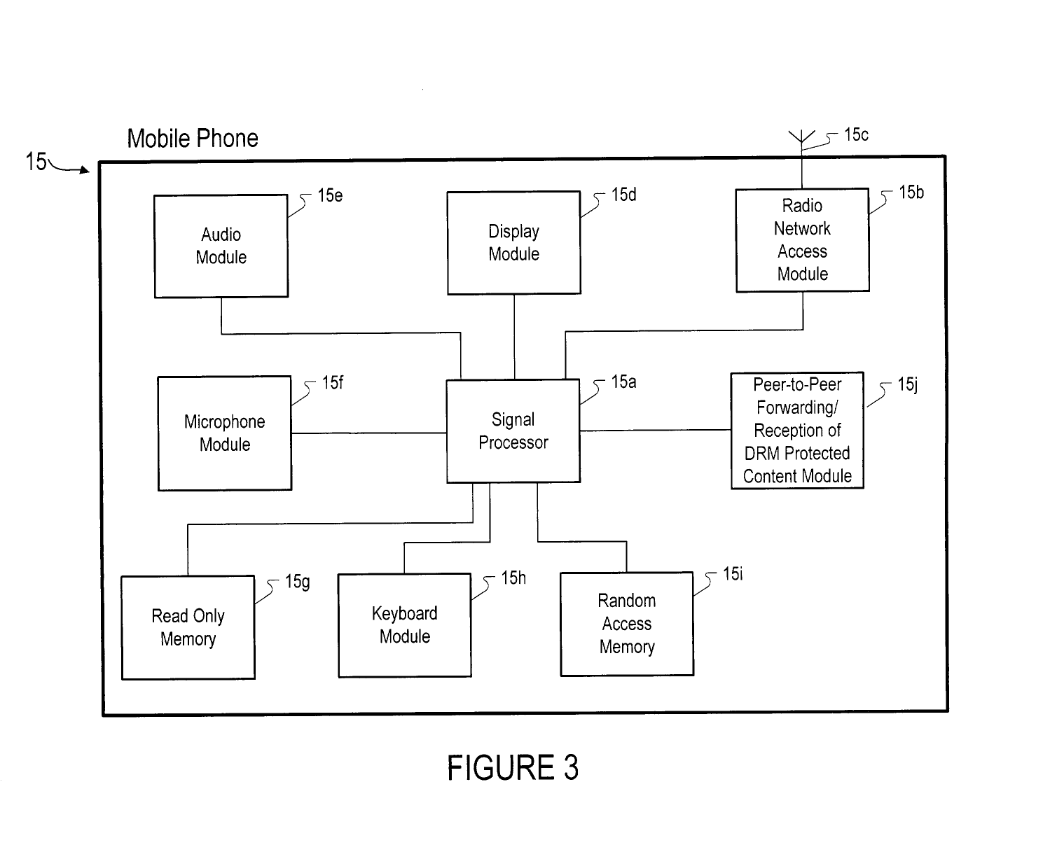

FIG. 3 shows a block diagram of a wireless terminal 15, like the wireless sender 12 or the wireless recipient 14. The wireless terminal 15 includes a signal processor 15a connected to a radio access network module 15b (connected to an antenna 15c), a display module 15d, an audio module 15e, a microphone 15f, a read only memory 15g (ROM or EPROM), a keyboard module 15h and a random access memory 15i (RAM). The signal processor 15a controls the operation of wireless terminal 15, the operation of which is known in the art. Moreover, the scope of the invention is not intended to be limited to any particular kind or type of the aforementioned elements 15a, 15b, . . . , 15i. For example, the scope of the invention is intended to include the radio access network module 15b being either an antenna module, a radio frequency (RF) module, a radio modem or the like. The wireless terminal 15 may also include many other circuit elements known in the art which are not shown or described.

The wireless terminal 15 features a peer-to-peer forwarding/reception of DRM protected content module 15j for encrypting or consuming protected content without requiring content personalization assistance from the network infrastructure 11 (FIG. 1), which is the whole thrust of the present invention. The peer-to-peer forwarding/reception of DRM protected content module 15j may be implemented using hardware, software, or a combination thereof. In a typical software implementation, the peer-to-peer forwarding/reception of DRM protected content module 15j would be a microprocessor-based architecture having a microprocessor, a random access memory (RAM), a read only memory (ROM), input/output devices and control, data and address buses connecting the same. A person skilled in the art of programming, especially programming of wireless terminals, would be able to program such a microprocessor-based implementation to perform the steps discussed above, as well as the steps discussed below, without undue experimentation.

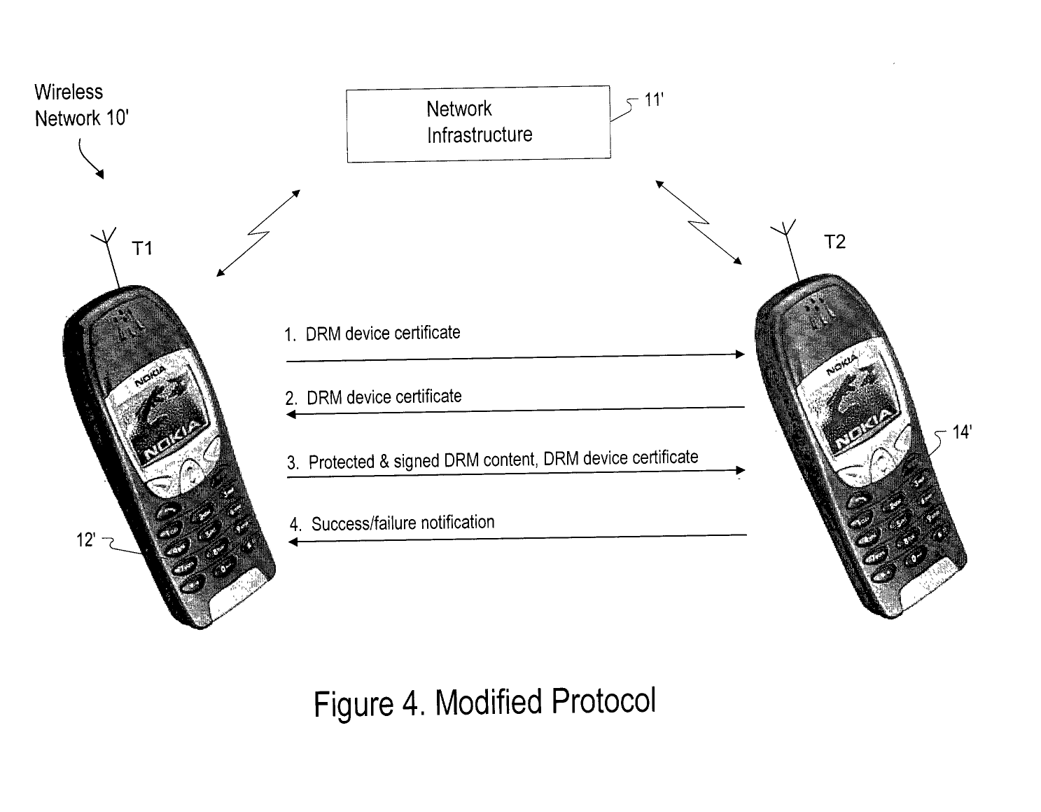

In an alternative embodiment discussed below in relation to FIG. 4, in the first step the wireless sender 12 may instead send a message having a device certificate rather than doing so in the third step, in lieu of sending the IMEI as shown in FIGS. 1 and 2.

### FIG. 1: Detail Description of DRM Protocol

FIG. 1 shows a typical message flow between the two terminals, T1 and T2, while forwarding the DRM protected content in the peer-to-peer fashion. In detail, the steps of the DRM protocol are as follows:

1. T1 -> T2: Sender name, international mobile equipment identity (IMEI) number, mobile station integrated service digital network number (MSISDN);

2. T2 -> T1: DRM device certificate;

3. T1 -> T2: Protected & signed DRM content (or content encryption key), DRM device certificate; and

4. T2 -> T1: Success/failure message

In step 1, a first terminal T1 sends a message to a second terminal T2 initiating the peer-to-peer forwarding. This message consists of, for example, some configurable sender name, the terminal's IMEI code, or the MSISDN.

In step 2, the second terminal T2 answers by sending to the first terminal T1 the DRM device certificate containing the public DRM key of the second terminal T2. The DRM device certificate provides information about, e.g., the secure creation and storage of the private DRM key of the second terminal T2.

In step 3, the first terminal T1 then verifies the public DRM key of the second terminal T2 by using the DRM CA public key securely installed to verify the DRM device certificate. If verification is successful, the first terminal T1 personalizes the DRM content by encrypting the content (or the content encryption key) with the public DRM key of the second terminal T2. The first terminal T1 then signs the encrypted DRM content (or the content encryption key) using its own private key. Note that the key used to sign DRM content (or content encryption key) to be forwarded does not have to be the same private DRM key used to decrypt received DRM content. It is not subject to the reversed threat model of DRM. Therefore, the key used to sign outgoing DRM content does not require strict usage control as the DRM private key used to decrypt DRM content. It is similar in nature to a wireless identity module (WIM) key, and, of course, still requires access control.

If necessary, proof of possession (POP) of the private DRM keys can easily be integrated into the DRM protocol.

In step 3, the first terminal T1 also sends the protected and signed DRM content (or the content encryption key) together with its DRM device certificate to the second terminal T2.

In step 4, the second terminal T2 verifies the accompanying DRM device certificate of the first terminal T1 using the securely installed DRM CA public key. If the certificate verification succeeds, the second terminal T2 verifies the signature of the first terminal T1 on the protected DRM content (or on the content encryption key). If this verification also succeeds, the second terminal T2 is able to consume the protected DRM content according to the specified rules of consumption. Note that consumption still requires applying the private DRM key of the second terminal T2. Finally, in order to make the protocol user-friendly, the second terminal T2 would typically confirm receipt of the personalized and signed DRM content. Embodiments are envisioned in which the terminal T2 does not send a success/failure notification to terminal T1. If an error has occurred during transmission, e.g., signature verification of the protected DRM content (or content encryption key) fails, the second terminal T2 responds with an error message indicating the failure.

It is possible for the first terminal T1 to resend the personalized DRM content (and/or content encryption key) (as in step 3) or to repeat the entire protocol. The latter, however, will most likely not be necessary, since eventual corruption of the DRM key during transmission in step 2 would have been detected by verifying the accompanying DRM device certificate.

If the second terminal T2 suspects that the received DRM content is pirated, it can inform the network infrastructure 11 (FIG. 1) and provide it with the pirated DRM content together with T1's DRM device certificate.

### FIG. 4: Alternative DRM Protocol Embodiment

FIG. 4 shows an alternative embodiment featuring a wireless network 10′ having a network infrastructure 11′ and two terminals 12′ (T1′), 14′ (T2′), in which it is possible to include neither the sender name, IMEI nor MSISDN in the first step 32 in FIGS. 1-2 of the DRM protocol. Instead, the following requirements could be implemented to preserve means of identification of terminals distributing pirated DRM content:

i) the DRM device certificate of the first terminal T1′ is sent to the second terminal T2′ in the first step instead of the sender name, IMEI, or MSISDN in the first step 32 in FIGS. 1-2; and the DRM device certificate of the first terminal T1′ is left out of the third step in FIGS. 1-2; and

ii) some DRM network entity, e.g., a DRM server, relates transparently for the user, the terminal's IMEI code to the corresponding DRM device certificate when connecting to the DRM system for the first time. Alternatively, the terminal's IMEI code may be included in the DRM device certificate at time of creation (during manufacturing process).

These modifications do not change the functionality of the DRM protocol. It merely provides a different way to gather the same information necessary to identify distributors of pirated DRM content.

Embodiments are also envisioned in which functionality is stored/handled using a subscriber identity module (SIM) card. For example, some device certificates could be stored on the SIM card as well as private key storage and operations. The SIM card can be used to implement part of the module/functionality.

### Terminal Manufacturing Considerations

In effect, every end-entity of a DRM system is equipped with a usually unique private DRM key (except in the group/domain concept in which a set of end-entities may share the same private DRM key). When personalizing a terminal with a private DRM key at manufacturing time, the manufacturer creates a certificate for the corresponding public key. This certificate is used as the DRM device certificate and provides information such as the security standards of the manufacturing process and the quality of the terminal's secure storage area containing the private DRM key. The certificate may also contain the terminal's IMEI. The certificate is signed with the manufacturer's private DRM CA key.

The DRM device certificate is then included in the wireless terminal. Note that it does not need to be stored in the confidentiality protecting secure storage area of the wireless terminal. It must, however, be integrity protected. An end-entity in the recipient role of DRM content sends this piece of information to the sender of DRM content in step 2.

Alternatively, the private DRM key may be generated on the terminal and the corresponding public key certified remotely by the manufacturer's DRM CA. Also in that case, it must be ensured that the terminal's device certificate is installed to the terminal in an integrity protected manner.

The public key matching the DRM CA's private key used to sign DRM device certificates must be included in every terminal's secure storage area. It is used by the wireless sender of DRM content to verify the authenticity and security properties of a terminal and its DRM key prior to personalizing the DRM content (or content encryption key) and sending it to the wireless recipient in step 3.

Note that multiple manufacturers can provide terminals for use in the same DRM system by adding the public keys matching the DRM CAs' private keys of multiple manufacturers to their respective terminals. This enables a manufacturer to easily allow or prevent the use of other manufacturers' terminals in a DRM system.

Including every manufacturer's DRM CA certificate on terminals, however, is not a very practical solution. Alternatively, cross-certification of manufacturers' DRM CAs, or an independent CA functioning as the root CA for all manufacturers' DRM CAs and including the root CA's certificate on all manufacturers' terminals can be used. In both cases, an additional certificate is included in steps 2 and 3 of the DRM protocol in FIGS. 1-2, respectively steps 1 and 2 of the DRM protocol in FIG. 4 (the one certifying a manufacturer's CA certificate).

### Advantages of the Invention

This invention provides a solution for operators of DRM systems, content owners, and customers, which all benefit in different ways.

This invention greatly enhances the process of distributing DRM protected content among potential customers. It increases usability for users forwarding DRM protected content. Thus, it enhances superdistribution and is therefore likely to increase revenue for operators and content owners.

The non-network centric nature of this invention eliminates the cost, e.g., of airtime, inherent to network centric approaches. In particular, the use of the known Bluetooth or infrared (IrD) means of communication for true peer-to-peer connections also diminishes any drawbacks resulting from multi-message protocols such as delays caused by long roundtrip times.

Terminals are assigned significant power by being able to personalize DRM content (or content encryption keys) for other terminals. Due to the reversed threat model in DRM, i.e., every user is a potential adversary, the application controlling the DRM functionality must provide a certain degree of tamper resistance. This requirement, however, is not specific to this invention only. Rather, it is a strict requirement to any DRM system.

Compromise of the DRM CA's private key used to sign DRM device certificates is likely to constitute the most severe threat. This extremely sensitive key, however, is not contained in any phone. It remains solely at the manufacturer's or CA's premises and is not subject to the reversed threat model of DRM. It requires the same protection as any CA's private key. For security reasons, this key should be of sufficient strength to also withstand brute-force attacks.

It might be considered an advantage for a terminal to only process centrally authenticated, i.e., centrally signed, content. Since the invention assigns end-entities the power to personalize content, it is not possible to centrally sign personalized content with a key common to all end-entities. This, however, does not constitute a problem.

Rather, in order to provide authenticity and limit distribution of pirated DRM content, every terminal signs DRM protected content using its own private DRM key when forwarding it. This provides the advantage for any third party to determine the originator of pirated content, and thus enabling legal actions. End-entities in the recipient role of DRM protected content verify the authenticity of the sender of the personalized content using the public key of the DRM CA (securely stored locally) and the sender's DRM device certificate accompanying the personalized content.

If the recipient of DRM content realizes pirated DRM content was sent, they can report the information gathered during the DRM protocol's initial message (FIG. 1 and FIG. 4), possibly together with the pirated content, as well as the information gathered in step no. 3, i.e. the sender's DRM certificate, to some network entity, e.g., the one handling payment transaction of legally obtained DRM content. End-entities reporting distributors of pirated DRM can be rewarded using a variety of different means, e.g., free DRM content (that otherwise costs money), credit for free speech time applied to the phone bill, etc.

The actual reward for honest terminals contributing to identification of distributors of pirated DRM content is expected to depend on a number of factors such as DRM content value, ratio of pirated DRM content to legal DRM content, detection ratio, etc.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

For example, the meaning of DRM content is not restricted to the content in its original meaning, e.g., picture, sound, movie, game. Rather, it also addresses all assets enabling consumption of the actual content. It also comprises terms such as vouchers, licenses, rights, content encryption keys (when hybrid encryption is used), or content encryption keys accompanied or included in vouchers, licenses, rights, etc.

I claim:

1. A method for forwarding peer-to-peer content in a wireless network having a network infrastructure, characterized in that a wireless sender encrypts protected content or content encryption key and a wireless recipient consumes the protected content without requiring content personalization assistance from the network infrastructure.

2. A method according to claim 1, characterized in that the wireless sender sends an initial message having an international mobile equipment identity, a sender name or mobile station international integrated subscriber digital network number to the wireless recipient.

3. A method according to claim 2, characterized in that the wireless recipient sends a device certificate having a public key to the wireless sender.

4. A method according to claim 3, characterized in that the wireless sender personalizes the protected content or content encryption key for the wireless recipient.

5. A method according to claim 4, characterized in that the steps for personalizing include:
encrypting the content or content encryption key using a public key of the wireless recipient;
signing encrypted content or content encryption key using a private key of the wireless sender; and
sending the protected content or content encryption key together with a device certificate of the wireless sender to the wireless recipient.

6. A method according to claim 4, characterized in that the wireless recipient verifies forwarded protected content received from the wireless sender by:
verifying the device certificate of the wireless sender; and
applying a private key of the wireless recipient in order for the recipient to consume the protected content.

7. A method according to claim 1, characterized in that the protected content is digital rights management protected content.

8. A wireless network having wireless terminals and a network infrastructure for forwarding peer-to-peer content from one wireless terminal to another wireless terminal, characterized in that at least two wireless terminals comprise a peer-to-peer forwarding/reception of DRM protected content module for either encrypting or consuming protected content without content personalization assistance from the network infrastructure.

9. A wireless network according to claim 8, characterized in that the peer-to-peer forwarding/reception of DRM protected content protocol module of a wireless sender sends an initial message having either an international mobile equipment identity, a sender name or mobile station international integrated subscriber digital network number to a wireless recipient.

10. A wireless network according to claim 8, characterized in that the peer-to-peer forwarding/reception of DRM protected content module of a wireless sender sends a device certificate having a public key to the wireless sender.

11. A wireless network according to claim 8, characterized in that the peer-to-peer forwarding/reception of DRM protected content module of a wireless sender personalizes the protected content or content encryption key for a wireless recipient.

12. A wireless network according to claim 12, characterized in that the peer-to-peer forwarding/reception of DRM protected content module of a wireless sender personalizes the content or content encryption key for a wireless recipient by:
encrypting the content or content encryption key using a public key of the wireless recipient;
signing encrypted content or content encryption key using a private key of the wireless sender; and
sending the protected content or content encryption key together with a device certificate of the wireless sender to the wireless recipient.

13. A wireless network according to claim 8, characterized in that the peer-to-peer forwarding/recipient of DRM protected content module of a wireless recipient verifies forwarded protected content from a wireless sender by:
verifying a device certificate of the wireless sender; and
applying a private key of the wireless recipient in order for the wireless recipient to consume the protected content.

14. A wireless network according to claim 8, characterized in that the protected content is digital rights management protected content.

15. A wireless terminal for operating in a wireless network having another wireless terminal and a network infrastructure for forwarding peer-to-peer content from the wireless terminal to the other wireless terminal, characterized in that each wireless terminal comprises a peer-to-peer forwarding/reception of DRM protected content module for either encrypting, consuming, or a combination thereof, protected content without content personalization assistance from the network infrastructure.

16. A wireless terminal according to claim 1, characterized in that the peer-to-peer forwarding/reception of DRM protected content module of a wireless sender sends an initial message having an international mobile equipment identity, a sender name or mobile station international integrated subscriber digital network number to a wireless recipient.

17. A wireless terminal according to claim 15, characterized in that the peer-to-peer forwarding/reception of DRM protected content module of a wireless sender personalizes the protected content for a wireless recipient.

18. A wireless terminal according to claim 17, characterized in that the peer-to-peer forwarding/reception of DRM protected content module of a wireless sender personalizes the content for a wireless recipient by:
encrypting the content or content encryption key using a public key of the wireless recipient;
signing encrypted content or content encryption key using a private key of the wireless sender; and
sending the protected content or content encryption key together with a device certificate of the wireless sender to the wireless recipient.

19. A wireless terminal according to claim 15, characterized in that the peer-to-peer forwarding/reception of DRM protected content module of a wireless sender sends a device certificate having a public key to a wireless sender.

20. A wireless terminal according to claim 15, characterized in that the peer-to-peer forwarding/recipient of DRM protected content module of a wireless recipient verifies forwarded protected content from a wireless sender by:
verifying a device certificate of the wireless sender; and
applying a private key of the wireless recipient in order for the wireless recipient to consume the protected content.

21. A wireless terminal according to claim 15, characterized in that the protected content is digital rights management protected content.

22. A method for forwarding a protected content or content encryption key from a first terminal to a second terminal, comprising the steps of:
sending an initial message from a first terminal to a second terminal;
sending a digital rights management device certificate containing a public digital rights management key from the second terminal to the first terminal;
verifying the public digital rights management key by the first terminal;
personalizing digital rights management content or content encryption key by encryption using a public key of the second terminal;
signing encrypted digital rights management content or content encryption key using a private digital rights management key of the first terminal;
sending encrypted and signed digital rights management content or content encryption key together with a digital rights management device certificate of the first terminal from the first terminal to the second terminal;
verifying the digital rights management device certificate of the first terminal by the second terminal; and
applying a private digital rights management key of the second terminal, if the private digital rights management key of the first terminal is verified, in order for the second terminal to consume the protected content.

23. A method according to claim 22, characterized in that the initial message includes a sender name, an international mobile equipment identity, a mobile station integrated service digital network number, or a combination thereof.

24. A method according to claim 23, characterized in that the method further comprises confirming receipt of the encrypted and signed digital rights management content or content encryption key from the second terminal to the first terminal.

25. A method according to claim 24, characterized in that the method further comprises sending an error message if verification of the encrypted and signed digital rights management content or content encryption key fails.

26. A method according to claim 22, characterized in that the sender sends an initial message having a device certificate to the wireless recipient.

27. A method according to claim 1, characterized in that the initial message includes a device certificate to the wireless recipient.
